(19) United States
(12) Patent Application Publication
(10) Pub. No.: US 2021/0196085 A1
(43) Pub. Date: Jul. 1, 2021

(54) DOOR HINGE

(71) Applicant: Kohler Mira Limited, Cheltenham, Gloucestershire (GB)

(72) Inventors: ADOLFO PLACENCIA, Cheltenham (GB); Scott Davis, Cheltenham (GB); Christos Nakos, Cheltenham (GB)

(21) Appl. No.: 16/328,422

(22) PCT Filed: Jul. 24, 2017
(86) PCT No.: PCT/GB2017/052158

§ 371 Date: Feb. 26, 2019

(51) Int. Cl. A47K 3/36; E05D 7/10; E05D 3/02; E05D 11/00

(52) U.S. Cl. CPC A47K 3/36; E05D 7/1072; E05F 3/02; E05D 11/0054; E05D 3/02

(57) ABSTRACT

A hinge that includes a first hinge portion that attaches to a side edge of a shower door panel, the first hinge portion having a pin protruding vertically therefrom; and a second hinge portion that attaches to a support and cooperating with the first hinge portion so that the shower door panel hinges between open and closed positions about an axis of rotation, the second hinge portion having a vertical socket that receives the pin, wherein the socket has a lateral opening to receive the pin, and a retainer member that covers the opening to retain the pin in the socket, and wherein the socket allows rotation of the pin within the socket; wherein the first and second hinge portions are arranged, in use, such that the axis of rotation is adjacent to the side edge and substantially between front and rear faces of the shower door panel.

### CROSS-REFERENCE TO RELATED PATENT APPLICATIONS

This application is a U.S. National Stage of International Application No. PCT/GB2017/052158, filed Jul. 24, 2017, which claims priority to and the benefit of Great Britain Priority Application 1615220.9, filed Sep. 7, 2016. The entire disclosures of each of the foregoing applications, including the specification, drawings, claims and abstract, are incorporated herein by reference in their entireties.

### BACKGROUND

This invention relates to a door hinge. The invention has particular but not exclusive application to hinge assembly for a shower door, to a shower cubicle employing the hinge assembly and to a method of installing a shower door using the hinge assembly.

### SUMMARY

For convenience, the invention is discussed primarily in relation to shower cubicles. The skilled person will appreciate that other applications of the hinge are possible.

It is a desired aim of the invention to provide a door hinge assembly which allows a shower door panel to be more easily installed.

It is another desired aim of the invention to provide a door hinge assembly which does not detract from the appearance of a shower cubicle.

It is another desired aim of the invention to provide a frameless door hinge assembly.

According to a first aspect of the invention, there is provided a door hinge assembly for a shower door panel having a front face, a rear face and a side edge between the front and rear faces, the door hinge assembly comprising a first hinge portion arranged, in use, to be attached to the side edge of the shower door panel, and a second hinge portion arranged, in use, to be attached to a support and to cooperate with the first hinge portion so that the shower door panel can hinge between an open position and a closed position about an axis of rotation, the first and second hinge portions being arranged, in use, such that the axis of rotation is adjacent to the side edge of the shower door panel and substantially between the front and rear faces of the shower door panel.

The axis around which the panel is arranged, in use, to rotate may be referred to as the axis of the hinge or the axis of rotation.

By locating the axis of rotation between the front and rear faces of the shower door panel, the axis of the hinge can be located in line with the panel and may provide a smoother, more aesthetically pleasing appearance in use.

Optionally, the axis of rotation may be positioned equidistant from each of the front and rear faces of the shower door panel, such that the axis is arranged centrally with respect to a width of the shower door panel. Advantageously, the symmetrical arrangement may provide a more aesthetically pleasing appearance.

According to a second aspect of the invention, there is provided a shower door comprising a panel having a front face, a rear face and a side edge between the front and rear face, and a hinge portion attached or attachable to the panel, the hinge portion being arranged, in use, to allow rotation of the panel around an axis when the hinge portion is coupled to a second hinge portion, wherein the axis of rotation lies adjacent to the side edge and substantially between the front and rear faces of the panel.

Optionally, a portion of the panel may be cut away or the panel may be shaped to have an indentation such that the axis lies within the footprint of the panel. In examples in which the axis lies within the footprint of the panel, some or all of the hinge portion may lie within the footprint of the panel. Advantageously, this may reduce the amount of space taken up by a hinge in addition to being aesthetically pleasing.

Optionally, the hinged panel may have more than one hinge portion attached or attachable thereto. For example, two, three or four hinge portions may be present. Each hinge portion on a given side of the panel is arranged to allow rotation of the panel around the same axis. Advantageously, the use of multiple hinge portions provides multiple support points, so making the panel more stable in use and/or distributing the weight of the panel more evenly.

According to a third aspect of the invention, there is provided a shower cubicle including a door hinge assembly for a shower door according to the first aspect of the invention, a shower door panel to which the first hinge portion is attached and a support to which the second hinge portion is attached.

Optionally, the support may be another panel.

According to a fourth aspect of the invention, there is provided a hinge assembly for a shower door including a first hinge portion with a pin protruding vertically therefrom, a second hinge portion with a vertical socket arranged, in use, to receive the pin, wherein the socket has a lateral opening to receive the pin and a locking tab arranged, in use, to cover the opening to retain the pin in the socket.

By providing the locking tab for the lateral opening to the socket, the pin can be inserted through the lateral opening into the socket in a direction substantially transverse to the axis of the pin and the locking tab secured to close the opening and prevent the pin coming out of the socket through the lateral opening. In this way, a shower door provided with the hinge assembly can be installed by pushing the door horizontally into position.

Optionally, the pin and socket may be configured so that the pin can pass through the lateral opening in a pre-determined angular position of the first and second hinge portions relative to each other. For example a transverse width of the pin may vary around a circumference of the pin so that the pin can pass through the lateral opening when a minimum width of the pin is aligned with the opening and is prevented from passing through the opening when the minimum width is non-aligned with the opening. In this way, a shower door provided with the hinge assembly can be installed by locating the door to align the minimum width of the pin with the lateral opening in the socket and pushing the door horizontally to insert the pin in the socket and then rotating the door so that the pin can no longer pass through the opening so as to hold the door in place whilst the locking tab is secured to cover the opening.

Optionally, the cross-section of the pin has at least one flattened edge defining the minimum transverse width of the pin. In some embodiments, the pin may have two flattened edges, which may be opposite each other. The two flattened edges may be equal in size. In this way, the hinge may be non-handed.

The skilled person will understand that the hinge assembly of the first aspect of the invention may comprise the hinge assembly of the fourth aspect of the invention. In such cases, the engagement of the pin in the socket defines the axis of rotation arranged to lie between the front and rear faces of the panel.

According to a fifth aspect of the invention, there is provided a shower cubicle including: a door panel, a fixed panel, and at least two hinge assemblies according to the fourth aspect of the invention, wherein the hinge assemblies connect the door panel to the fixed panel for movement relative to the fixed panel.

Optionally, the hinge assemblies are arranged such that the pin of one hinge assembly protrudes upwards and the pin of the other hinge assembly protrudes downwards. With this opposed arrangement of the hinge assemblies (i.e. the two pins pointing in opposite directions), the door cannot be lifted or lowered vertically so as to disengage the hinge assemblies.

According to a sixth aspect of the invention, there is provided a kit of parts for installation of a shower door panel comprising a shower door panel and at least two hinge assemblies according to the first or fourth aspects of the invention.

According to a seventh aspect of the invention, there is provided a method of installing a shower door panel using the kit of parts according to the sixth aspect of the invention, the method including: (i) positioning the shower door panel such that the pins of the first hinge portions are aligned with the lateral openings to the sockets of the second hinge portions; (ii) moving the shower door panel horizontally such that the pins pass through the aligned lateral openings of the sockets; and (iii) securing the locking tabs across the lateral openings.

The method may further comprise moving the shower door panel horizontally so that a minimum transverse width of at least one pin is aligned with and passes through the lateral opening of the socket and rotating the shower door panel such that the minimum transverse width of the at least one pin is not aligned with the lateral opening of the socket.

Optionally, one pin protrudes vertically upwards and the other pin protrudes vertically downwards. Advantageously in such cases, the first hinge portion having the pin protruding vertically downwards is supported by the second hinge portion and the first hinge portion having the pin protruding vertically upwards supports the second hinge portion. Further, advantageously the first hinge portion having the pin protruding vertically downwards is the uppermost hinge assembly.

The skilled person will appreciate that features discussed in relation to any one aspect of the invention may be provided with any other aspect of the invention.

### BRIEF DESCRIPTION OF THE DRAWINGS

Embodiments of the invention will now be described in more detail by way of example only with reference to the accompanying drawings in which like reference numerals are used for like features:

FIG. 1 is a view of a shower door assembly of an embodiment including two hinge assemblies;

FIGS. 2a and 2b show close-up views of a hinge assembly of FIG. 1;

FIG. 2c shows a cross-sectional view of a hinge pin used in the embodiment of FIGS. 1 and 2a and 2b;

FIG. 3 shows a door and a panel to which the door is arranged to be attached, arranged to form the shower door assembly of FIG. 1;

FIGS. 4a and 4b show how the shower door assembly of FIG. 1 is assembled;

FIG. 5 shows a schematic view of the shower door assembly of FIG. 1 illustrating the use of locking tabs;

FIG. 6 shows a close up of a hinge assembly according to FIG. 5;

FIG. 7 shows the hinge assembly of FIG. 6 with the locking tab fully engaged;

FIG. 8 shows the completed shower door assembly corresponding to FIG. 5;

FIG. 9 shows a cross-section of one of the hinge portions with a locking tab;

FIG. 10 shows an exploded view of a shower door assembly of a second embodiment;

FIG. 11 shows a close-up of an assembled hinge assembly according to the embodiment of FIG. 10;

FIG. 12a shows a schematic perspective view of a hinged panel and its axis of rotation according to various embodiments of the invention; and

FIG. 12b shows a schematic plan view of a hinged panel and its axis of rotation according to various embodiments of the invention.

### DETAILED DESCRIPTION

Referring to the drawings, a shower door assembly 100 for a shower cubicle is shown.

The shower door assembly 100 includes a door panel 102, a fixed panel 104 to which the door panel 102 is connected and two hinge assemblies 110, 120. The panels 102, 104 may be made of a transparent or translucent material. In some embodiments the panels 102, 104 may be made of glass. In alternative embodiments, the panel 104 may be a wall or other surface or support. In alternative or additional embodiments, more than two hinge assemblies 110, 120 may be provided allowing the load borne by each hinge assembly to be reduced.

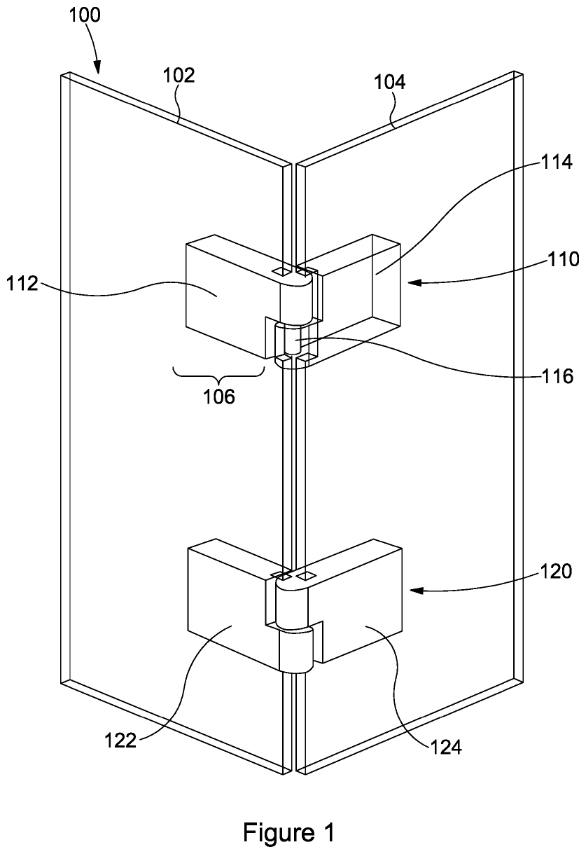

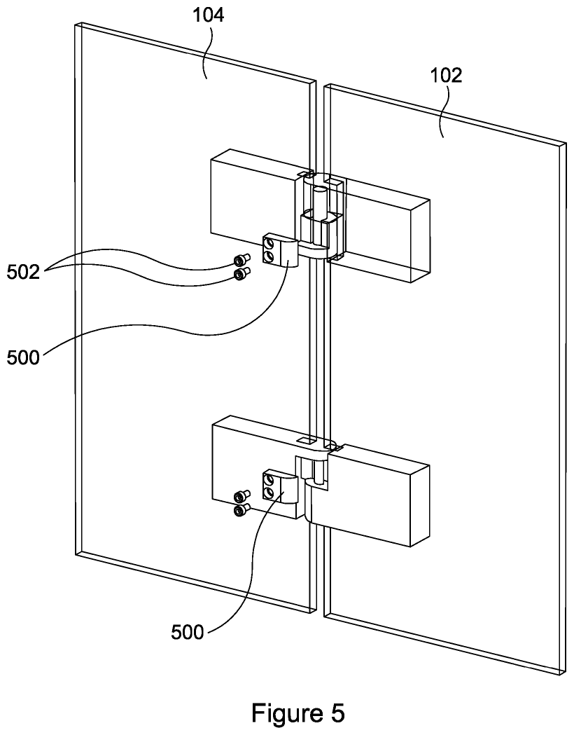

In the embodiment being described, the door panel 102 and fixed panel 104 are substantially flat rectangular panels having front and rear faces, opposed vertical side edges and opposed horizontal top and bottom edges. The hinge assemblies connect adjacent side edges of the panels 102, 104 and support the door panel 102 for hinging movement between an open position shown in FIG. 1 and a closed position shown in FIG. 5. In the open position, the door panel 102 extends at an angle to the fixed panel 104 to open an opening for access to and from a shower area. In the closed position, the door panel 102 is substantially aligned with fixed panel 102 to close the opening to the shower area.

Each hinge assembly 110, 120 includes two hinge portions 112, 114, 122, 124. One hinge portion 112, 122 of each hinge assembly is attached to the door panel 102. The other hinge portion 114, 124 of each hinge assembly is attached to the fixed panel 104. The skilled person would understand that it is immaterial which hinge portion of a pair is attached to the door panel 102 and which to the fixed panel 104, provided that the pairs align and correspond.

Each hinge portion 112, 122 has a body portion 106 arranged, in use, to be attached to the door panel 102 or the fixed panel 104. In the embodiment being described, the door panel 102 and fixed panel 104 are shaped such that the body portion 106 slots around or into a portion of the door 102 or panel 104. In some embodiments, the panels 102, 104 may be provided with cut-away portions in the regions of each hinge portion 112, 114,122,124. Advantageously, the indentations/cut-away portions allow at least a portion of the volume of the hinge portions to lie within the footprint of the door 102 and panel 104.

The body portion 106 has one edge which lies substantially parallel to, and near to, the edge of the door 102 or panel 104 to which it is attached which is nearest to the intended hinge location. As such, the axis of rotation defined by the hinge is adjacent to, and at least substantially parallel to, that edge of the door 102 or panel 104.

At the edge of each body portion 106 nearest to the intended hinge location, each hinge portion 112, 114 has a protruding portion 312, 314 having an at least substantially vertical cavity or indentation therein. In the embodiment being described, hinge portion 112 has a vertical cavity and hinge portion 114 has a vertical indentation. In the embodiment being described, each protruding portion 312, 314 lies between the planes defined by the front and rear panels of the door 102 or panel 104 to which it is attached. As such, the axis of rotation defined by the hinge lies between the planes defined by the front and rear faces irrespective of whether or not the axis of rotation lies within the footprint of the door 102 or panel 104. In this context, the footprint of the door or panel means the area covered by the door or panel, in particular the floor-space covered by the door/panel itself during use.

In the embodiment being described, hinge portion 112 has its protruding portion 312 in an upper portion of the hinge portion 112 and may be described as the upper hinge portion. Hinge portion 114 has its protruding portion 314 in a lower portion of the hinge portion 114 and may be described as a lower hinge portion. The protruding portions are arranged to correspond such that, in use, the protruding portion of one hinge portion 112 rests on the protruding portion of the corresponding hinge portion 114.

The skilled person would understand that it is immaterial which hinge portion 112, 1114 is attached to the door 102 and which to the panel 104, and which hinge portion is the upper section and which is the lower section.

The cavity of the upper hinge portion 112 extends from the bottom of the protruding portion upwards into the protruding portion.

The indentation of the lower hinge portion 114 extends from the top of the protruding portion downwards into the protruding portion.

In the embodiment being described, the protruding portions of the upper 112 and lower 114 hinge portions have substantially the same maximum cross section.

In the embodiment being described, the protruding portion 314 of the lower hinge portion 114 has two portions which are integral—a plate portion 414a and a receiving portion 414b. The plate portion 414a is an at least substantially flat and horizontal portion at the lower side of the hinge portion 114. The plate portion 414a has at least substantially the same cross-sectional area and shape as the upper hinge portion 112.

The receiving portion 414b extends upwards from the plate portion 414a. The receiving portion 414b includes the vertical indentation 416, which is positioned substantially on a midline of the protruding portion 314. The plate portion 414a provides a ledge which is at least partially not covered by the receiving portion 414b and the indentation 416. In the embodiment being described, the receiving portion 414b has a smaller cross-sectional area than the plate 414a, and the edge of the receiving portion aligns with the edge of the plate except in the region of the ledge.

In alternative or additional embodiments wherein the hinge portion with the indentation 416 rests on top of a hinge portion with a cavity, the hinge portion with the cavity supports the receiving portion 414b. In such embodiments, the plate portion 414a is not necessary to support the door 102 and may not be present. However, for reasons of aesthetics and consistency of manufacture, the plate portion 414a may be provided even when not required in use. Further, the plate portion 414a may serve as a guide to installers even when not used for support.

In use, the cavity and the indentation 416 are arranged to align vertically.

Each hinge assembly 110, 120 further includes a pin 116. Hinge portion 114 is drawn to be transparent in FIG. 1 to allow the pin 116 to be seen. An equivalent pin 126 is present within the hinge assembly 120 but is not visible in FIG. 1 due to being obscured by the hinge portions 122, 124. Each pin 116, 126 lies adjacent to the edge of the door/panel on which the hinge lies and defines an axis of rotation which is between the planes defined by the front and rear faces of the door/panel.

The pin 116 is arranged to fit into both hinge portions 112, 114, so coupling the two sections of the hinge assembly 110 together. The pin 116 sits within the cavity of one hinge portion 112 and within the indentation 416 of the other hinge portion 114.

In alternative embodiments, the pin 116 is integral with one of the hinge portions 112, 114, and the other hinge portion 114, 112 has an indentation arranged to receive the pin 116 which protrudes from the first hinge portion. In such embodiments, a cavity is not needed.

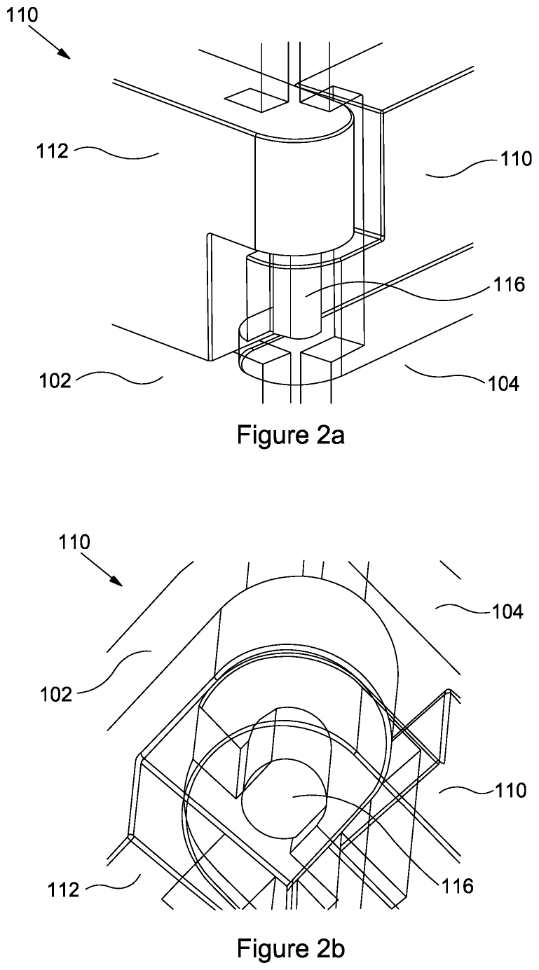

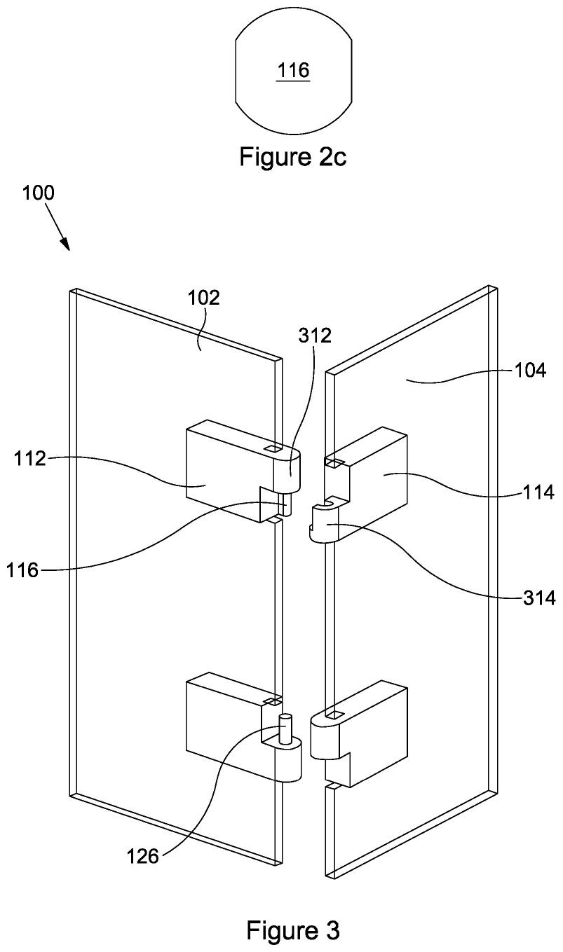

FIG. 2c shows a cross-sectional view of the pin 116. The pin 116 is substantially cylindrical, with two opposite sections cut away such that two sides of the pin 116 are flattened. In the embodiment shown, each flattened edge reduces the width of the pin by approximately 1/12. For example, for a pin 116 with an effective diameter of 12 mm for the circular portion, each flattened edge would take off 1 mm such that the width at the narrowest point is 10 mm. Preferably, the reduction in width is small enough to allow reasonably smooth rotation of the pin whilst being large enough to see by eye where the flattened areas are. In alternative or additional embodiments, each flattened edge may reduce the width by between 1/16 and ⅙ of the effective diameter. The effective diameter of the pin 116 may be between 2 mm and 30 mm, and preferably between 5 mm and 20 mm.

In embodiments having a cavity in one hinge portion 112, the cavity is shaped to receive the pin 116. Advantageously, in at least some embodiments, the cavity is arranged such that the pin 116 cannot rotate within the cavity.

In embodiments not having a cavity, the pin 116 is integral with, and extends from, the hinge portion 112.

The hinge portion 112 with the pin 116 extending therefrom may be referred to as a male hinge portion.

The indentation 416 in the hinge portion 114 is arranged to receive the section of the pin 116 which extends from the other hinge portion 112. The indentation 416 has an opening 418 which is narrower than the widest point of the indentation and narrower than the diameter of the pin 116, such that the flattened edges of the pin 116 must be correctly aligned to allow the pin 116 to be pushed into the indentation horizontally.

The hinge portion 114 with an indentation 418 arranged to receive the pin 116 may be referred to as a female hinge portion.

In the embodiment being described, the opening 418 is approximately 11 mm wide, so allowing the narrowest pin width of 10 mm to comfortably enter the indentation 416 whilst preventing the widest pin width of 12 mm from doing so. The skilled person would understand that the minimum width for the opening is the narrowest pin width and the maximum width for the opening is slightly smaller than the maximum pin width/the effective diameter of the circular portion of the pin 116.

The indentation 416 is shaped to allow rotation of the pin 116 within the indentation.

In alternative embodiments, the cavity may be arranged to allow rotation of the pin 116 and the indentation 416 may be arranged not to allow rotation of the pin.

FIG. 3 shows a door 102 and a separate panel 104, each provided with pre-assembled hinges as described above. Again, the axis of rotation lies adjacent to, and substantially parallel to, an edge of the door/panel to which the hinge is attached, and between the planes defined by the front and rear faces of the door/panel.

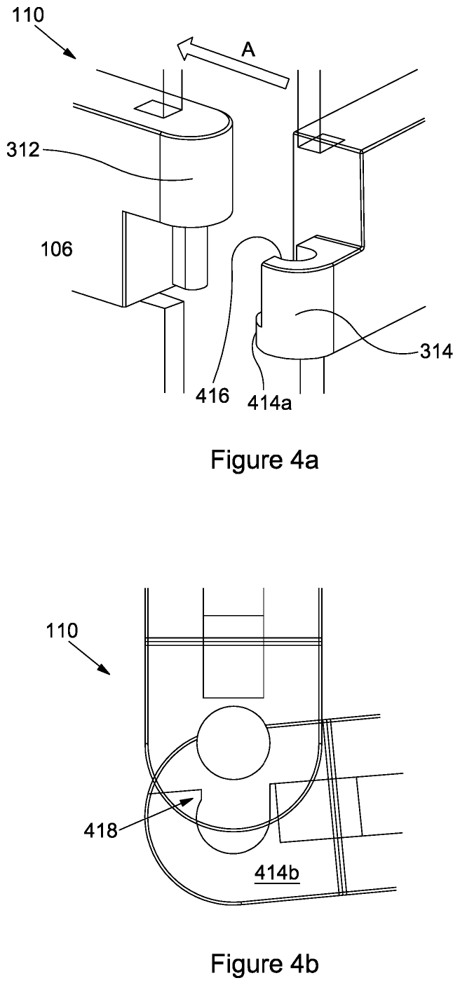

FIGS. 4a and 4b illustrate how the door 102 and panel 104 are connected. Arrow A indicates the direction of movement required for assembly.

To assemble a door according to the embodiment being described, the door 102 is positioned such that the pin 116 which extends downwardly from the hinge portion 112 attached to the door 102 rests on the plate portion 414a of the hinge portion 114 attached to the panel 104 from which the door 102 is to be hinged.

The door 102 is angled such that the flattened sides of the pin 116 align with the narrow opening 418 to the indentation 416 of the hinge portion 114. Advantageously, the angle of the door 102 relative to the panel 104 can be changed by rotation whilst allowing the plate portion 414a to support some or all of the weight of the door 102.

The door 102 can then be pushed horizontally such that the pin 116 slots into the indentation 416.

Advantageously, the pin 116 is positioned such that the door 102 is in an open position when the pin aligns with the narrow opening 418. This may facilitate access to lift and appropriately angle the door 102. Closing the door 102 then engages the hinge assembly 110 such that the pin 116 cannot move horizontally out of the indentation 418 when the door is in the closed position.

A locking plate 500 is then attached to the hinge portion 114 having the indentation 416 such that the pin 116 is no longer able to be moved horizontally out of the indentation 418 in any door position. In the embodiment being described, two screws 502 are used to secure the locking plate 500 in place. The skilled person would understand that other securing means could be used, for example, more or fewer screws, welding, adhesive, a latch or the like, or any combination of the above.

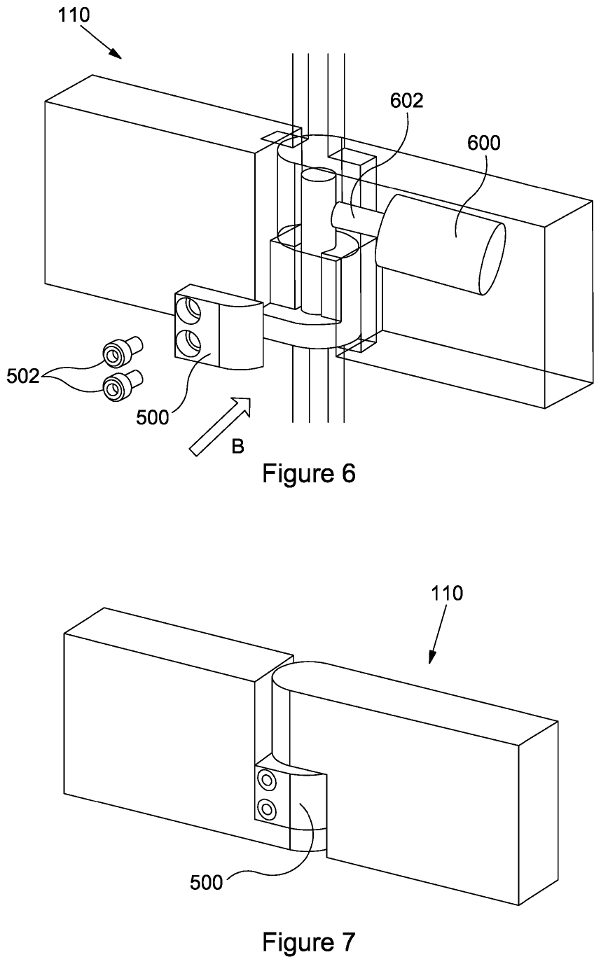

In the embodiment shown in FIG. 6, the locking plate 500 is inserted into position on the receiving portion 414a by movement in the direction marked by arrow B.

In the embodiments being described, the locking plate 500 is secured to the receiving portion 414b of the hinge portion 114. In these embodiments, the outer vertical surface of the locking plate aligns with the outer vertical surface of the plate portion 414a, so providing a substantially smooth and continuous surface of the hinge portion 114.

Advantageously, the hinge assembly fully supports the weight of the door such that the door does not need to be otherwise supported whilst the locking plate is attached. In this way, an individual can assemble the door 102 without requiring assistance.

The method of assembling a door 102 therefore includes the steps of: (1) positioning the door 102 such that the end of the pin 116 rests on the plate portion 414a of the corresponding hinge portion 114; (2) rotating the door 102 such that the flattened edges of the pin 116 align with the opening 418 of the indentation 416; (3) sliding the door 102 horizontally such that the pin 116 fits within the indentation 416; (4) rotating the door 102 such that the flattened edges of the pin 116 do not align with the opening 418 of the indentation 416; and (5) securing a locking plate 500 across the opening 418.

In embodiments in which the pin has only one flattened edge, that edge is arranged to be at least substantially perpendicular to the opening in step (2).

Advantageously, the installer only needs to support the weight of the door 102 during step (1), which should be of short duration.

In additional or alternative embodiments, the protruding portion of the hinge portion 114 may be supported by the receiving portion 414b as well as, or instead of, the pin 116 bearing the load.

Correspondingly, the method of removing a door 102 from its hinges therefore includes the steps of: (1) rotating the door 102 such that the flattened edges of the pin 116 do not align with the opening 418 of the indentation 416 (advantageously, in this position, the locking tab is not necessary to keep the pin locked in place); (2) removing the locking plate 500 across the opening 418; (3) rotating the door 102 such that the flattened edges of the pin 116 align with the opening 418 of the indentation 416; (4) sliding the door 102 horizontally such that the pin 116 slides out of the indentation 416 (the weight of the door advantageously still being supported at this point); and (5) removing the door 102 from the doorway.

In the embodiment being described, two hinge assemblies 110, 120 are used.

Advantageously, the hinge assemblies 110, 120 are oriented such that one of the hinge portions 112, 122 on the door 102 forms the upper hinge portion of its corresponding hinge assembly 110, 120 and the other hinge portion 122, 112 on the door 102 forms the lower hinge portion of its corresponding hinge assembly 120, 110. In this way, the door 102 cannot be lifted off its hinges, nor pulled downward off its hinges, as vertical movement in either direction is blocked by the hinge portions 114, 124 of the panel 104. This arrangement may be described as the two hinge assemblies 110, 120 being opposed.

In the embodiment shown in the figures wherein the pins 116, 126 protrude vertically from the hinge portions 112, 122 on the door, the pins 116, 126 therefore protrude in opposite directions.

In at least some embodiments of the invention, the locking plate 500 not only serves to prevent the pin 116 from becoming dislodged from the indentation, but also provides a self-closing mechanism for the door 102.

In these embodiments, the locking plate 500 is secured such that it is biased towards the opening 418 of the indentation 416. In particular, the locking plate 500 is arranged to lie flat across the opening 418 and in contact with the receiving portion 414b on both sides of the opening.

When the flattened sides of the pin 116 are parallel to the locking plate 500, which is the closed position of the door 102 in these embodiments, the pin lies fully within the indentation 418.

When the flattened sides of the pin 116 are not parallel to the locking plate 500, i.e. when the door 102 is partially or fully open, the pin protrudes from the opening 416, pushing against the locking plate 500. The locking plate 500 therefore serves to bias the door 102 towards the closed position. In embodiments wherein the door 102 can be opened by more than 90°, this biasing mechanism holds the door open when it is opened beyond 90°. The same mechanism can therefore both close doors which have been left partially ajar, and keep open doors which have been deliberately opened wide, e.g. for cleaning or airing.

In at least some embodiments, the locking tab 500 has a protrusion 510 arranged, in use, to lie at least partially within the indentation 416. Advantageously, the pin 116 is therefore fully contained within the indentation 416 at all angles of rotation whilst still allowing the locking tab 500 to exert a force on the pin 116. In such cases, the locking tab 500 as a whole may or may not be biased towards the pin 116—in cases in which the locking tab 500 as a whole is not biased towards the pin 116, the protrusion 510 is biased towards the pin, for example by being spring-loaded.

In the embodiment shown in FIG. 6, the hinge assembly 110 further includes a soft close device 600. The soft close device 600 has a moving portion 602 which is biased towards and in contact with the pin 116. The moving portion 602 provides an interference fit between the pin and the soft close device. Advantageously, the interference fit reduces the velocity of rotation of the pin 116 and therefore of the door 102, so avoiding the door 102 slamming shut. Preferably, the resistance to rotation due to friction provided by the interference fit is less than the biasing due to the locking tab 500 such that the self-closing function provided by the locking tab 500 is achieved.

In the embodiment shown, the soft close device 600 has a tube 602 fitting closely within a cylinder in which it moves up and down against a liquid or gas, and so may be described as a piston. The skilled person would understand that the precise shape chosen is immaterial.

In alternative embodiments, no soft close device is used.

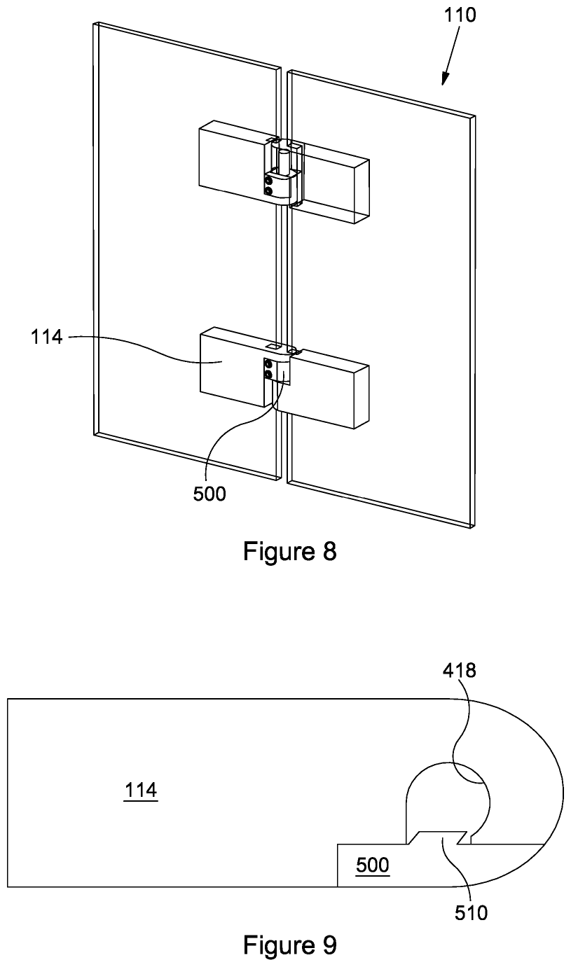

In the embodiments described with respect to FIGS. 1 to 9, the pin 116 is positioned vertically between the door 102 and the panel 104. There is therefore a small gap between the door 102 and the panel 104 when the door and panel lie parallel to each other.

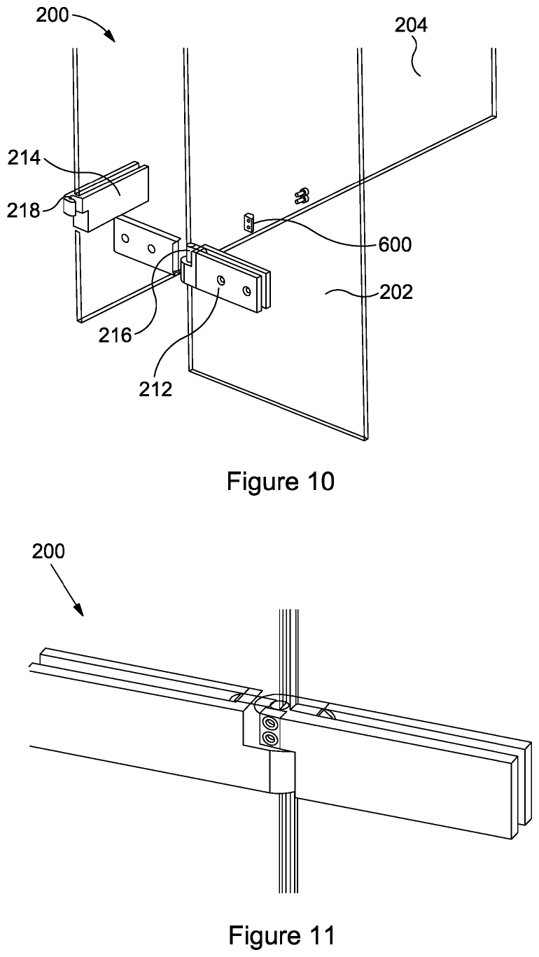

In some cases, it may be advantageous to reduce this gap. The embodiment shown in FIGS. 10 and 11 is one example of how this can be achieved. Like reference numerals are used to reference like features; with 102 and 202 both denoting doors, for example.

In the embodiment shown in FIGS. 10 and 11, the pin 216 lies within the cross-sectional area of the door 202. The axis of rotation therefore also lies within the cross-sectional area of the door 202. The door 202 and the panel 204 each have indentations/cut-away portions in the region of the hinge assemblies. For hinge assemblies of equivalent size, these indentations/cut-away portions are larger than those of the embodiments described above so as to allow more of the length of the protruding portions of each hinge portion 212, 214 to lie within the cross-sectional area of the door or panel.

In alternative or additional embodiments, the pin 216 could lie within the cross-sectional area of the panel 204. The skilled person would understand that corresponding cut-out portions/indentations and protrusions in the door 202 and panel 204 would be needed in embodiments in which the pin lies within the cross-sectional area of the door 202 and of the panel 204.

In the embodiment shown in FIGS. 10 and 11, the locking plate 600 does not provide a self-closing mechanism. The locking plate 600 prevents the pin 216 from escaping from the indentation 218. In alternative embodiments, the locking plate 600 may provide a self-closing mechanism as described above.

In the embodiments being described, the door 102, 202 and panel 104, 204 are made of glass. In alternative or additional embodiments, other materials such as metal and/or polymers such as Perspex may be used.

In the embodiments being described, the hinge assemblies 110, 210, 120, 220 are made of metal. In alternative or additional embodiments, other materials, for example polymers, may be used. The locking tab 500, 600 and the pin 116, 126 may be made of the same material or of a different material from the hinge portions 112, 114, 122, 124.

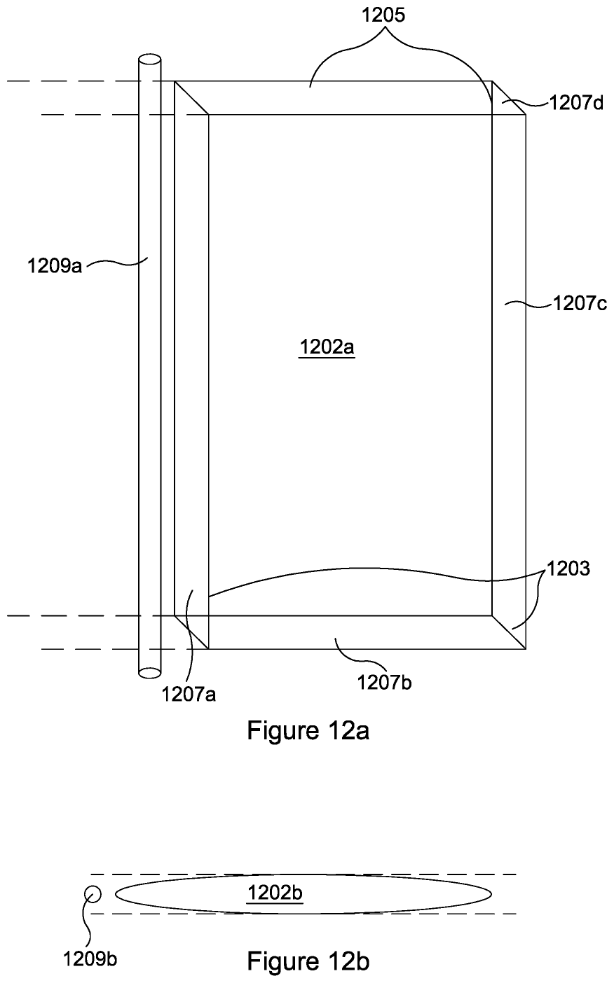

FIG. 12 shows a schematic view of a door panel 1202a. The door panel 1202a is substantially cuboid in shape and has a front face 1203 and a rear face 1205 which are of significantly larger surface area than any other face. Each face 1203, 1205 is planar and therefore lies in one particular plane. Each face 1203, 1205 may therefore be said to define a plane.

Between the front and rear faces 1203, 1205 is an edge 1207a-d. The edge 1207a-d separates the planes defined by the two faces 1203, 1205.

In alternative embodiments, the door panel 1202b may be curved such that the edges 1207a-d are not separated from the faces 1203, 1205 by sharp corners but are instead continuous with the faces. In such cases, each face 1203, 1205, although gently curved, will still be substantially planar to allow function as a door or panel and the skilled person would understand that a plane appropriate for each face can be determined from the widest point(s), as shown in FIG. 12b. Further, although the edges 1207a-d are continuous with the faces, edge regions can be clearly identified by the skilled person and serve the same function. A hinge portion can therefore be attached in an edge region such that the axis of rotation lies adjacent to the edge region and between the planes defined by the faces.

In use, a hinge portion is attached to the door panel 1202a, 1202b such that the pin or other element defining an axis of rotation 1209a, 1209b is adjacent to, and at least substantially parallel to, an edge 1207a or edge region of the door panel 1202a, 1202b to which the hinge portion is connected. The axis of rotation 1209a, 1209b is arranged to lie between the planes defined by the two faces 1203, 1205.

It will be understood that the invention is not limited to the embodiments above-described and the skilled person will appreciate that modifications can be made within the scope of the invention as defined by the claims.

In particular, the specific hinge mechanism described is not the only mechanism which would permit the axis of rotation to lie between the planes defined by the two faces of a hinged panel and should not be taken to limit the other aspects of the invention, but rather as an example implementation which may offer further advantages. For example, one or more circular, U-shaped or semi-circular hooks could be provided on one edge of a door, with the hook lying between the planes defined by the faces of the door or panel, as one hinge portion and one or more corresponding pins, arranged to accept the hooks, could be provided on the support or other panel to which the door is to be hingedly attached.

1-24. (canceled)

25. A hinge assembly for a shower door panel having a front face, a rear face and a side edge between the front and rear faces, the door hinge assembly comprising:
a first hinge portion arranged, in use, to be attached to the side edge of the shower door panel, wherein the first hinge portion has a pin protruding vertically therefrom; and
a second hinge portion arranged, in use, to be attached to a support and to cooperate with the first hinge portion so that the shower door panel can hinge between an open position and a closed position about an axis of rotation, wherein the second hinge portion has a vertical socket arranged, in use, to receive the pin, wherein the socket has a lateral opening to receive the pin, and a retainer member arranged, in use, to cover the opening to retain the pin in the socket, and wherein the socket is shaped to allow rotation of the pin within the socket;
wherein the first and second hinge portions are arranged, in use, such that the axis of rotation is adjacent to the side edge of the shower door panel and substantially between the front and rear faces of the shower door panel.

26. The assembly of claim 25, wherein the axis of rotation is positioned equidistant from each of the front and rear faces of the shower door panel, such that the axis is arranged centrally with respect to a width of the shower door panel.

27. The assembly of claim 25, wherein the pin can be inserted through the lateral opening into the socket in a direction substantially transverse to the axis of the pin and the retainer member secured to close the opening and prevent the pin coming out of the socket through the lateral opening.

28. The assembly of claim 25, wherein the pin and socket are configured so that the pin can pass through the lateral opening in a predetermined angular position of the first and second hinge portions relative to each other.

29. The assembly of claim 28, wherein a transverse width of the pin varies around a circumference of the pin so that the pin can pass through the lateral opening when a minimum width of the pin is aligned with the opening and is prevented from passing through the opening when the minimum width is nonaligned with the opening.

30. The assembly of claim 29, wherein a cross-section of the pin has at least one flattened edge defining the minimum transverse width of the pin.

31. The assembly of claim 30, wherein the pin has two flattened edges opposite each other.

32. A hinge assembly for a shower door, the hinge assembly comprising:
a first hinge portion with a pin protruding vertically therefrom; and
a second hinge portion with a vertical socket arranged, in use, to receive the pin, wherein the socket has a lateral opening to receive the pin and a retainer member arranged, in use, to cover the opening to retain the pin in the socket.

33. The assembly of claim 32, wherein the pin can be inserted through the lateral opening into the socket in a direction substantially transverse to the axis of the pin and the retainer member secured to close the opening and prevent the pin coming out of the socket through the lateral opening.

34. The assembly of claim 32, wherein the pin and socket are configured so that the pin can pass through the lateral opening in a predetermined angular position of the first and second hinge portions relative to each other.

35. The assembly of claim 34, wherein a transverse width of the pin varies around a circumference of the pin so that the pin can pass through the lateral opening when a minimum width of the pin is aligned with the opening and is prevented from passing through the opening when the minimum width is nonaligned with the opening.

36. The assembly of claim 35, wherein a cross-section of the pin has at least one flattened edge defining the minimum transverse width of the pin.

37. The assembly of claim 36, wherein the pin has two flattened edges opposite each other.

38. A method of installing a shower door panel using a door hinge assembly comprising a first hinge portion comprising a pin protruding vertically therefrom and arranged, in use, to be attached to the side edge of the shower door panel, and a second hinge portion wherein the second hinge portion has a vertical socket arranged, in use, to receive the pin, wherein the socket has a lateral opening to receive the pin, and a retainer member arranged, in use, to cover the opening to retain the pin in the socket, and wherein the socket is shaped to allow rotation of the pin within the socket, the second hinge portion being arranged, in use, to be attached to a support and to cooperate with the first hinge portion so that the shower door panel can hinge between an open position and a closed position about an axis of rotation, the method comprising:
positioning the shower door panel such that the pin of the first hinge portion is aligned with the lateral opening to the socket of the second hinge portion;
moving the shower door panel horizontally such that the pin passes through the aligned lateral opening of the socket; and
securing a retainer member across the lateral opening.

39. The method of claim 38, wherein the pin has a minimum transverse width of that is aligned with the lateral opening of the socket in a first orientation of the pin relative to the opening and is not aligned with the lateral opening of the socket in a second orientation of the pin relative to the lateral opening of the socket, the first and second orientations being angularly spaced apart.

40. The method of claim 38, wherein the shower door panel is installed with two or more hinge assemblies.

41. The method of claim 40, wherein the pin of a first hinge assembly protrudes vertically upwards and the pin of a second hinge assembly protrudes vertically downwards.

42. The method of claim 41, wherein the second hinge assembly having the pin protruding vertically downwards is the uppermost hinge assembly.
